(19) United States
(12) Patent Application Publication
(10) Pub. No.: US 2016/0097616 A1
(43) Pub. Date: Apr. 7, 2016

(54) Laser Guided and Laser Powered Energy Discharge Device

(71) Applicant: Adam Mark Weigold, (US)

(72) Inventor: Adam Mark Weigold, San Francisco, CA (US)

(73) Assignee: Dr. Adam Mark Weigold, San Francisco, CA (US)

(21) Appl. No.: 13/684,483

(22) Filed: Nov. 23, 2012

Related U.S. Application Data
(60) Provisional application No. 61/563,617, filed on Nov. 25, 2011.

(51) Int. Cl. F41H 13/00; G21K 5/10; G21K 1/00; H01S 3/23; H01S 3/00

(52) U.S. Cl. CPC F41H 13/0062; H01S 3/23; H01S 3/005; G21K 1/003; G21K 5/10

(57) ABSTRACT

The present invention relates to a laser guided and powered directed energy weapon that combines two different lasers to accurately and efficiently deliver a high energy electromagnetic pulse (EMP) to a target at long range. The method uses a high energy laser pulse with relatively long pulse duration focused in air to create a plasma ball which emits an intense EMP. Typically the long pulse duration of high energy lasers would severely limit focal accuracy and effective range because of air pressure variations and pollutants in the atmosphere. However the present invention uses a second ultrafast laser to create a long thin optical plasma filament between the variable location of the plasma ball and the target to act as a stable electrical connection or conducting wire. Consequently EMP can be efficiently channeled to the target via the optical filament, thereby dramatically increasing potential accuracy, range and energy delivery efficiency.

### REFERENCE TO RELATED APPLICATIONS

This application is related to and claims priority from U.S. provisional Application No. 61/563,617 filed Nov. 25, 2011 entitled Laser Guided and Laser Powered Energy Discharge Device which is incorporated fully herein by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### TECHNICAL FIELD OF THE INVENTION

The present invention relates to a method of using a laser based device to produce electrically charged or ionized plasma in air which can discharge energy in various forms to a target with applications including use as a directed energy weapon

### BACKGROUND OF THE INVENTION

The use of laser based devices as directed energy weapons for the purpose of causing disorientation, damage or destruction of a target is well known. Various laser based devices have been developed for use against a variety of targets including missiles, aircraft, land vehicles, naval vessels, sensor equipment, military installations, mines, improvised explosive devices (LED's) and even human beings. Laser based directed energy weapons can be broadly classified into three main categories based on the laser-target interaction mechanism and its application; namely laser disorientation, laser heating and laser guided weapons. Advantages of laser based directed energy weapons include high accuracy, long range, speed of light velocities, immunity to the effects of gravity and wind and the potential of both lethal and of non-lethal applications. The majority of applications for laser based weapons are defensive in nature but offensive laser weapons are also possible.

Laser disorientation weapons use a laser beam to confuse, disorientate or damage the optical sensors of a target and include air-air countermeasure systems and laser blinding weapons. These laser disorientation systems rely on confusing or damaging the targets optical sensor using pulses of light with typical wavelengths in the infrared and mid-infrared spectrums. Whilst the pulses of light typically have very high peak powers due to their short pulse widths, their pulse energies are typically less than 1 J and the number of pulses per second can be as little as 1 Hz to 100 Hz. Consequently laser disorientation systems typically use solid-state laser devices which are relatively small in size and low in average output power with typical average powers in the range of 1 W to 10 W. It is important to note that laser disorientation systems only damage the delicate optical sensor or the eyes of the target, thereby reducing the targets effectiveness in combat. However these devices cannot significantly damage or destroy a target as a whole. An example of this prior art is given by Sepp, et al. (2003) in U.S. Pat. No. 6,587,486 which describes a directional infrared countermeasures weapons system.

Laser heating weapons use very high power lasers to heat, vaporize or ignite the surface of a target and burn through the more delicate interior causing significant damage or even destruction of the target. Laser heating weapons typically use chemical lasers such as pulsed deuterium fluoride lasers with very high pulse energies in the mid-infrared spectrum or continuous wave chemical oxygen iodine lasers with very high average output powers in the infrared spectrum. Both pulsed and continuous wave chemical lasers typically produce very high average output powers in the range of 1 kW to several megawatts. Unfortunately, compared to solid-state lasers, chemical lasers suffer numerous disadvantages. They are very inefficient in turning electrical power into optical power, they have reduced reliability and lifetime, and the handling of the chemical fuels can be problematic and dangerous. Consequently chemical laser devices are very large in nature and have very high electrical power consumption requirements making them difficult to design for a portable platform with an acceptable degree of safety, reliability and lifetime. For the most part these laser systems have been limited to installations at stationary land based sites with dedicated power stations or on board naval warships that are equipped with nuclear power plants. However recent advances in chemical laser technology have reduced the size of chemical lasers and their power plants so they can potentially fit inside a Boeing 747 aircraft as in the US Air Forces Airborne Laser and Advanced Tactical Laser Programs Nonetheless these efforts at system portability are still in early development stage and have proved technically difficult and hugely expensive. An example of this prior art is given by Hook et al. (2004) in U.S. Pat. No. 6,785,315 which describes a mobile tactical high energy laser weapon system.

Laser heating weapons can also suffer from several disadvantages in terms of their practical use and application against a specific target. The laser beam is typically focused to as small a spot size as possible onto the targets surface, thereby maximizing the laser intensity on the target to provide the most rapid heating as possible. The absorption of the laser light by the target is dependent on the wavelength of the laser and the optical absorption by the target material. Whilst metallic targets readily absorb the light in the infrared and mid-infrared spectrums from chemical lasers it is possible to either use non-metallic materials or to coat metal surfaces with materials that reflect a high proportional of the incident laser light thereby reducing the absorption and heating of the target. Moreover there are many potential targets that are not made of metallic materials and may exhibit reduced absorption in the infrared and mid-infrared spectrums. Consequently it is conceivable that potential targets of laser heating weapons may be constructed using reflective materials that may significantly reduce the weapons effectiveness.

Another potential disadvantage of laser heating weapons is the creation of an ablation cloud near the targets surface. When the laser beam heats and ablates the surface of the target, the evaporated target material forms an ablation cloud that can absorb some of the laser energy, thereby reducing the ability of the laser beam to burn further through the volume of the target. The further the beam penetrates into the target material the more dramatic the effect of the ablation cloud on the laser beam. This effect is dependent on the nature and thickness of the material and also on the duration of the laser beam on the target. Ablation clouds effectively increase the optical power requirements of the laser for effective penetration into the target and complex techniques are often implemented to minimize their effect.

Another potential disadvantage of laser heating weapons is the effect of laser induced breakdown and blooming The laser beam is focused to a small spot on the targets surface producing an increasing power density profile with propagation distance. If the beam size is small enough such that the laser power density reaches a certain threshold level then laser induced breakdown can occur. Laser beams with power densities of the order of 10¹²-10¹³ W/cm² and above cause breakdown in the air and plasma is produced. The exact laser power density threshold above which breakdown occurs in a gas depends on the various constituents of the gas and the gas pressure. Above threshold breakdown occurs via the absorption of laser energy by atoms and molecules in the gas resulting in ionization of the atoms and molecules. This results in high density plasma consisting of positive ions and free electrons. The highly energetic free electrons can also collide with other nearby atoms causing additional ionization resulting in additional free electrons being produced via a cascade effect. Breakdown manifests itself in the appearance of a spark along the laser propagation path and can be viewed as a form of laser generated lightning. The negative effects from laser breakdown are twofold. Firstly, the process of ionization absorbs a significant portion of the laser energy before it reaches the target, thereby reducing the amount of laser energy that can be directed onto the targets surface. Secondly, the laser generated plasma produces the blooming effect which defocuses and disperses the laser beams propagation path. This results in a larger than desirable spot size on the target which corresponds to a reduced power density on the target. Consequently both absorption and defocusing effects can dramatically reduce the ability of the laser to rapidly heat and ablate the targets surface in the required timeframe.

With respect to the present invention, it is important to note that laser breakdown in air is typically a non-deterministic process that cannot be accurately predicted in terms of location. This is because the laser pulse duration from high energy lasers is typically in the range of tens of nanoseconds to hundreds of microseconds. Over this relatively long time scale many atomic and molecular collisions occur and these collisions ultimately determine the threshold level for ionization and plasma generation during the laser pulse duration. Hence small variations in relative gas constituents and gas pressure can result in large variations in the power density required for laser induced breakdown. Lasers focused over several kilometers to a target can produce laser breakdown or sparks that occur randomly over a range of tens of meters or more before the target. In general, the negative effects from laser induced breakdown and blooming can be more severe if there is fog, smoke or dust in the air. However the exact position along the beams propagation path at which breakdown will occur cannot be known or controlled with any useful degree of accuracy. The most commonly used method to counter potential laser breakdown is to use a wide diameter laser beam that when focused on the target can only reach the power density threshold for laser breakdown when the beam is very close to or at the targets surface. In some instances the focal spot of the laser beam may actually be beyond the targets surface to minimize the risk of laser breakdown.

Laser guided weapons typically detect the reflected spot from a laser beam on a target with an optical sensor to accurately guide or aim a kinetic weapon to the target. Most commonly the kinetic weapon is a gun or missile, the laser aiming device is in the visible or infrared spectrums and the optical sensor is the human eye or an infrared photo-detector. An example of this prior art is de Filippis et al. (1980) in U.S. Pat. No. 4,233,770 which describes a laser aiming device for weapons.

More recently however, a new type of laser guided weapon has been developed which is a laser guided electrical discharge weapon or laser guided energy weapon (LGE). This device uses an optical filament produced from an ultrafast laser to guide an electrical discharge to a target. As described earlier, when a high energy laser pulse with a pulse-width ranging from nanoseconds to hundreds of microseconds reaches the ionization threshold in air then laser breakdown occurs. Because of collisional processes that occur within this timeframe the breakdown is relatively non-deterministic in nature and the location of the laser induced plasma cannot be accurately determined or controlled. However if an ultrafast laser with pulse-widths of the order of femtoseconds or picoseconds is used to create the plasma then the ionization process occurs much faster than any collisional processes. In this case the breakdown process is highly deterministic in nature and the location of the laser induced plasma can be accurately determined and controlled. Moreover, the focus of a narrow ultrafast laser beam can be balanced against the defocusing effects of blooming in the plasma and a long collimated filament of plasma can be formed in air. Optical filaments of ionized plasma have been produced with lengths ranging from tens of centimeters up to tens of meters. An example of this prior art is McCahon et al. (2003) in U.S. Pat. No. 7,277,460 which describes the generation of optical filaments by use of localized optical inhomogeneities. The majority of LGE development work using energy discharges via optical filaments has been performed by researchers at US company Applied Energetics Inc. and has been summarized in many of their marketing publications (see www.appliedenergetics.com) and partially described by Lundquist et al. (2003) in U.S. Pat. No. 7,050,469.

While an ultrafast laser may have sufficiently high peak power to ionize air in relatively long narrow filaments, it does not have sufficient pulse energy to ionize a sufficient volume of air to create highly energized plasma such that it can be used as a weapon. Nonetheless ultrafast lasers do create sufficient ionized plasma densities to allow electrical discharges to be transmitted down the length of the optical filament. In other words the optical filaments can be viewed as electrical wires in air. One or more filaments can be controlled to form an electrical circuit between the target and a high voltage source. Hence the optical filaments can be used to guide a high voltage discharge to the target over a distance of several tens of meters to disorientate, disable or damage the target. Whilst still in early development stage, laser guided energy weapons (or LGE devices), have been successfully demonstrated against targets including improvised explosive devices (or IED's). This technology has been used to develop laser guided energy weapons that are powered via passing the laser adjacent or through electrodes or phase plates charged with high voltages from electrical storage and discharge devices such as capacitors or thyratrons. These devices are therefore laser guided but electrically powered and exhibit both advantages and disadvantages of both technologies. The electrically powered nature of this weapon has significant advantages over laser heating weapons in terms of amount of energy transferred, energy transfer efficiency, size, power requirements, the lack of ablation cloud issues and the tunable ability for both non-lethal and target disorientation applications. Several hundred thousands of volts can be transmitted by optical filaments using an LGE system and electrical power plant that can be fitted within a large land based vehicle such as a truck. However this technology is also limited in range because it is powered via electrical discharge devices. The major limiting factor with this technology is the range of the weapon from the high voltage source to the target is limited to not the range of the laser but the length of the optical filament that can be generated. For all practical embodiments the location of the high voltage source is fixed to nearby the laser device. Hence, whilst the laser beam might be able to propagate many kilometers in air, the range of this type of laser guided weapon is limited to the maximum length of the optical filaments, which is typically only a few hundred meters at most. Creating optical filaments longer than tens of meters is impractical in terms of both ultrafast laser power capabilities and optical focusing arrangements that are used to balance the laser focusing with optical defocusing effects from blooming Consequently this type of LGE technology suffers from a lack of range which is one of the main reasons for utilizing a laser based weapon in the first instance.

There exists a need for a laser based weapon system that has greater destructive or disabling potential than existing laser disorientation weapons, has much smaller footprint and power requirements than existing laser heating weapons, and has much greater range than existing laser guided energy weapons. What is ideally required is a relatively small, power efficient laser based weapon that can designed to either disorientate, damage or destroy a wide variety of targets, that can be used for both lethal and non-lethal applications and also has a potential range of several kilometers or more.

### BRIEF SUMMARY OF THE INVENTION

According to the present invention, although this should not be seen as limiting the invention in any way, there is provided a method of first using an ultrafast laser device to guide the energy of the weapon to the target and secondly using a high energy laser device to deliver a high energy pulse of electromagnetic or electrical energy for the target. Both processes rely on laser produced breakdown to convert optical energy into emitted electromagnetic energy or stored electrical energy. The invention can be described as the first LGE type weapon that is both laser guided and laser powered using separate laser devices for each process. We can describe the technology as Laser Guided and Powered Energy technology (or LGPE) which is a new class of LGE technology. Therefore, when compared to existing LGE technology, the LGPE invention does not suffer the disadvantage of a limited range associated with electrically powered LGE devices. Because the invention has a potential range of several kilometers or more it has a much wider variety of potential applications than conventional LGE technology. Furthermore, many of these new longer range applications require much less energy to be delivered to the target meaning potential reductions in system size and weight. It should be noted that although the conversion of electrical efficiency into optical efficiency for solid state and semi-conductor based lasers is typically 5-40%, the required reduction in power for many long range applications can be several orders of magnitude in size. It is conceivable that for some embodiments of the invention, the size and weight might be only 5-20% of the size and weight typical of conventional LGE systems.

Laser guidance for the invention is achieved via the accurate control of the deterministic process of laser induced breakdown from an ultrafast laser to create long narrow optical filaments of plasma in air. Laser powering is achieved via the relatively non-deterministic process of laser induced breakdown from a high energy laser to create a much larger and highly energized volume of plasma in air. The spatial overlap of these two laser produced plasmas results in a single plasma in air that can be both accurately targeted and significantly powered to store high levels of energy in the form of high speed electrons and ions. The high energy portion of the plasma can produce an intense electrical pulse and/or an intense electromagnetic pulse that can be directed and efficiently conducted down the filament's length towards a target. As the filament portion of the plasma can be accurately controlled so that it is always close to or touching the target, high levels of electrical energy can be discharged into the target causing either disorientation, damage or destruction of the target.

The process of laser guidance is achieved via focusing the output from an ultrafast laser device to produce an optical filament of plasma in air such that the end of the filament reaches the surface of the target. The length of the optical filament may be tens of meters or more and the distance of the filament from the ultrafast laser device can be accurately controlled via the optical focusing arrangement because the ionization process for ultrafast laser pulses is deterministic in nature. Because the filament is not required to be in contact with a conventional high voltage source that is fixed to a location nearby the laser device the potential range of the optical filament is determined by the optical focusing arrangement and can potentially be several kilometers or more in distance.

The process of laser powering is achieved via focusing the output from a high energy laser device to produce a highly energetic volume of plasma at some point along the length of the optical filament produced by the ultrafast laser device. Whilst this process is relatively non-deterministic or random in nature it is only non-deterministic along the axis of propagation of the laser. Therefore it can be focused or controlled such that it overlaps the long optical filament of plasma. As long as the two plasmas spatially overlap at some point along the axis of propagation they effectively form a single combined plasma volume that possesses the spatial characteristics and power density characteristics of both individual plasmas. Such a combined plasma volume has the potential to have both a significant amount of energy stored in it and to be accurately positioned to ensure contact with the target. As long as the plasma has contact with the surface of the target a significant amount of the stored electrical energy in the plasma will be discharged into the target via the creation of an electrical current circulating through the plasma and the target, or via the conduction of an electromagnetic pulse (EMP). It may be the case that in the region of plasma overlap the optical filament from the ultrafast laser actually helps to seed the laser breakdown from the high energy laser or effectively helps to reduce the threshold power level required to form laser breakdown. This may result in the reduction of variation in the position of the highly energetic plasma in the region of overlap between the two plasmas. However the two plasmas typically have vastly different spatial characteristics, volumes and plasma densities so this seeding effect may occur only near the limited volume of plasma overlap. Consequently, while the overall effect of seeding may be beneficial in producing more accurately targeted plasma, the process of the optical filament seeding the large volume plasma is not specifically required for the invention to work. The invention only requires that the formation of the large volume plasma occurs at some point along of the optical filament. Furthermore the relatively long time scale of the high energy laser pulse means that the formation of the large volume highly energized plasma is still non-deterministic to some degree. Consequently potential seeding processes in the region of volume overlap are not considered critical to the design of the invention. It is the spatial volume and potential stored energy of the combined plasma that is critical to the potential effectiveness of the invention. The only critical requirement here is that there exists some degree of spatial and temporal overlap of the large volume plasma and the optical filament.

It is conceivable that energy can be discharged from the high energy plasma via the optical filament to the target from either (a) the electrical spark or discharge of current between the plasma and target with different potential voltages or (b) the emission of an intense electro-magnetic pulse (EMP) from the plasma towards the target, or both.

The electrical pulse can conduct down the optical filament because it acts as an electrically conducting path or “wire” in air. The EMP can be readily and efficiently conducted down the optical filament because it is typically in the microwave or radio frequency part of the electromagnetic spectrum which can be readily conducted by optical filaments in air. Many researchers have proposed and demonstrated the efficient transmission of electromagnetic signals down an optical filament created by an ultrafast laser. One such publication of note is titled the “Electromagnetic (EM) Wave attachment to laser plasma filaments” by D. C Freedman (Technical Report ARWSE-TR-09004, May 2009, U.S. Army Armament Research and Development and Engineering Center). Hence both electrical energy and electromagnetic energy can be efficiently transmitted down the optical plasma filament to the target with minimal loss. It should be noted at this stage of the discussion that the high energy plasma ball, in addition to producing an electrical charge and an EMP, also produces other forms of energy including an acoustic shockwave and a broadband optical pulse. The broadband optical pulse is also an electromagnetic pulse but with a much shorter wavelength than that of the EMP emission in the microwave or radio-frequency part of the electromagnetic spectrum. However the broadband optical pulse cannot be channeled by a filament width that is so relatively large, and hence the optical pulse will not be conduct efficiently down the optical filament to the target. Nonetheless the optical pulse will readily transmit through air without being channeled by the filament. Therefore the broadband optical pulse may also have significant potential for optical blinding and missile countermeasure applications such as the disruption and disorientation of infrared and optical sensors.

The process of electrical discharge of the stored energy from the plasma via the filament to the target is in some way analogous to the process of lightning where stored energy in clouds is discharged into the earth via conductive paths that appear as lightning bolts. Electrostatic charge stored in a cloud can induce an equal but opposite charge along the surface of the earth. Lightning bolts can then initiate the flow of electrons from the cloud via the most conductive path to the earth which is typically via the tallest object that is grounded to the earth. This process is typically followed by a return lightning strike which involves the flow of electrons back from the target to the cloud. It is the resultant electrical current that is produced via the flow of electrons between the earth and the clouds that enables the discharge of energy from the cloud to the earth. In the same way the highly energized portion of the plasma may induce an equal but opposite charge in the surface of the target. Energy discharge can typically occur via the flow of electrons along the optical filament to the target which is the most conductive path between the highly energized portion of the plasma and the target. Consequently energy discharge to the target may occur and stored electrical energy in the plasma will be delivered to the target via the flow of electrons through the optical filament and the target. A subsequent return flow of electrons at a reduced kinetic energy may occur from the target back to the plasma. Regardless of the exact nature of the energy discharge processes, when the plasma is in contact with the surface of the target an electrical current flows through the combined plasma-target body and energy is discharged from the plasma to the target. The creation of this current through the body of the target has the potential to damage parts of the target, especially components such as electronic circuits or sensors devices. The greater the electrical current flowing through the target the greater the potential is for damage to target components. Similarly, the greater the EMP energy directed towards the target the greater the potential is for damage to target components. EMP is well known to be damaging to electrical and electronic components (but relatively safe to biological matter) while electrical discharge currents can damage both electronics and other materials such as biological or metallic materials.

The relative pulse energy from the high energy laser controls the amount of energy that can be stored in the highly energized portion of the plasma and that ultimately can be delivered to the target. Consequently there exists the potential of controlling the amount of disorientation or damage to the target via the variation of the pulse energy from the high energy laser. In addition the size and power of the ultrafast laser can determine the length of the optical filament and its range. Hence the size and scale of both laser devices may be used to determine both the range and the discharge energy to the target, which in turn determines the application of the invention to a specific variety of targets and intended outcomes. In summary, targeting or guidance of the invention can be controlled via the ultrafast laser device whilst the degree of power or energy delivery can be controlled via the high energy laser device.

It is important to note that energy discharge via electromagnetic pulse (EMP) or electrical current may not be the only process that occurs via the creation of the overlapped laser produced plasma from two separate and different laser devices. In addition to a significant portion of the stored energy being delivered to the target via EMP or electrical discharge there exists the potential for the highly energized portion of the laser produced plasma to create an acoustic wave that propagates through air to the target. Furthermore, the formation of the plasma can typically result in the generation of a flash of intense optical output. The optical output will typically be broadband in nature with emission wavelengths potentially ranging from the x-ray and ultraviolet spectrums through to the visible, infrared, mid-infrared and far-infra-red spectrums. The peak emission wavelength of the optical flash may be determined by the temperature of the plasma according to the radiation spectrum emitted from a black-body source. Hence additional disorientation or damage may be caused to the target via an acoustic shock wave or optical flash from the plasma. It should be noted that any potential disorientation or damage from acoustic shock waves or optical flashes will be dependent on the proximity of the large volume of plasma to the target, but this will not require the optical filament to have direct contact with the surface of the target.

There also exists the possibility of using the output from the high energy laser to accelerate electrons or positively charged ions within the optical filament along the length of the optical filament via laser wake-field acceleration. The potential of laser wake-field accelerated particles to produce significant damage to a target may be doubtful for practical purposes because of typical requirements for near vacuum pressure conditions. However there may exist potential non-military applications of the invention relating to particle beam acceleration including, but not limited to, particle physics research and materials processing. In addition the production of a broadband optical flash also has non-military applications including, but not limited to, high intensity and collimated x-ray sources.

The present invention offers numerous advantages over existing technologies for many military applications. As an example, for applications including vehicle disabling, counter-IED devices and nonlethal anti-personnel devices, existing systems based on laser guided energy (LGE) technology rely on using optical filaments to guide an electrical current from a high voltage source to the target. Consequently these systems are limited in range to the length of the optical filament. This range is typically only tens of meters and over this distance there are numerous less expensive and smaller options available to the military other than an ultrafast laser based solution. In contrast to the laser guided but electrically powered nature of conventional LGE technology, the present invention is both laser guided and laser powered which means that the optical filament can be formed at a distance of several kilometers or more from source of the laser output. Hence the potential range of the invention is several kilometers or more which offers numerous advantages over conventional LGE based technology and other technologies for these applications.

As an added example of potential advantages of the invention, existing technologies for directional counter-measures applications typically use highly directional infrared or mid-infrared output from a laser targeted on a heat seeking missile to disorientate or confuse the missile. This technique is effective because the missile relies on guidance systems using infrared sensing of the heat profile from its target such as an aircraft or vehicle. A potential method for the missile to counter the effect of laser emission confusing its infrared sensors is to use optical filters on the infrared sensors to filter out only the narrow laser wavelengths so that the missile can more easily discern the broadband emission of the heat profile of the target. The present invention provides for the potential of producing a highly directional source of broadband emission in the infrared and mid-infrared spectrums that is much more similar to the broadband emission from the missiles target than the single distinct optical wavelengths from lasers. Consequently the broadband output from the invention would make it much more difficult for heat seeking missiles to use optical filter technology to counter directional countermeasure applications. Furthermore, the EMP/electrical current and/or acoustic shock waves produced by the present invention have the potential to provide additional disorientation to the missile, or may even damage or disable the missile. Consequently the present invention provides for three potential forms of directional countermeasures processes from a single device. There exist various other potential applications of the invention and in turn there may exist additional advantages over prior art which are dependent on the exact nature of the application and the current effectiveness of existing technologies for the specific application.

In summary, the primary purpose of the invention is as a weapon, with a potential range up to several kilometers or more, that produces highly energized laser produced plasmas that can be accurately guided to a target so that energy is transferred to the target via an electromagnetic pulse or an electrical current flowing between the highly energized plasmas and the target via an optical filament in air. Additional benefits for military applications are also possible via the production of an acoustical shock wave and a broadband optical flash. There exist many potential military applications including, but not limited to, directional countermeasure systems, anti-IED systems, target disorientation devices, vehicle disabling devices, non-lethal and lethal anti-personnel devices. Furthermore, several potential non-military applications exist including, but not limited to, particle beam accelerators and x-rays sources. Various other potential applications of the invention may be developed without departing from the scope and ambit of the invention.

### BRIEF DESCRIPTION OF THE DRAWINGS

By way of example, employment of the invention is described more fully hereinafter with reference to the accompanying drawings, in which:

FIG. 1 shows a schematic overview of the two key elements of the present invention, namely (a) the optical filament of plasma produced by the focusing of an ultrafast laser in air and (b) the high energy density plasma produced by the focusing of a higher pulse energy laser in air.

FIG. 2 shows a schematic overview of an embodiment of the present invention as a combined whole employing an optical focusing arrangement with a single focusing lens.

FIG. 3 shows a schematic overview of an embodiment of the present invention as a combined whole employing an optical focusing arrangement with separate focusing lenses for each laser beam.

FIG. 4 shows a schematic overview of an embodiment of the present invention as a combined whole employing an optical focusing arrangement using 2 separate optical filaments to create either a closed circuit electrical pathway for electrical current to circulate between plasma ball and target, or multiple conductive paths to improve delivery efficiency of EMP energy to the target.

### DETAILED DESCRIPTION OF THE INVENTION

In a preferred embodiment of the invention, as a first step the output from an ultrafast laser is focused by a lens such that a narrow optical filament is formed in air. The convergence of the laser beam is balanced against the divergence of the defocusing effects from laser blooming such that the length of the optical filament is of the order of several meters or more. In addition, the process of creating an optical filament may be assisted or seeded with the use of phase plates or a diffracting aperture along the path of laser propagation. The ultrafast laser output may be produced from, but is not limited to, non-linear frequency multiplication of a mode-locked solid-state laser such as a Titanium doped Sapphire laser or a Neodymium doped Glass laser. Non-linear frequency multiplication can convert the infrared output from a laser to the ultraviolet spectrum which typically ionizes a gas with greater efficiency than infrared laser output and can also be focused to a smaller spot. The output from such a laser system consists of a train of laser pulses in the ultraviolet spectrum with pulse-widths of the order of femtoseconds or picoseconds. Pulse energies may typically vary between micro-joules up to several hundreds of milli-joules or more. In general, the greater the pulse energy of the laser pulses the longer the potential length of the optical filament of plasma that can be created.

Once a stable optical filament in air is formed, as a second step the output from a high pulse energy laser is focused at some location along the length of the optical filament formed by the ultrafast laser. The high energy pulsed output may be produced from, but is not limited to, either a free-running or Q-switched pulsed solid-state laser such as a Neodymium doped Glass laser or an Erbium doped Glass Laser. Alternatively the high energy pulsed output may be produced from, but is not limited to, a high power gas laser such as a Carbon Dioxide laser or a high power chemical laser such as a deuterium fluoride laser. The output from these high pulse energy lasers is typically in the infrared or mid-infrared spectrums. Frequency multiplication of the laser output to shorter wavelengths in the visible or ultraviolet spectrums may be preferable in terms of efficiency but this step is not considered critical to the invention. The output from these high energy lasers have typical pulse-widths varying from nanoseconds from Q-switched lasers to hundreds of microseconds or more from free-running lasers. Pulse energies may vary between sub-Joule levels to hundreds of Joules or even more. In general, the greater the pump pulse energy the larger the volume of air that can be ionized and the more energy that can be stored in the plasma and discharged into the target. Variation of this pulse energy may be used to vary the power and application of the invention. The spatial and temporal combination of the output from the two separate laser devices produces a Laser Guided and Powered Energy device (or LGPE device).

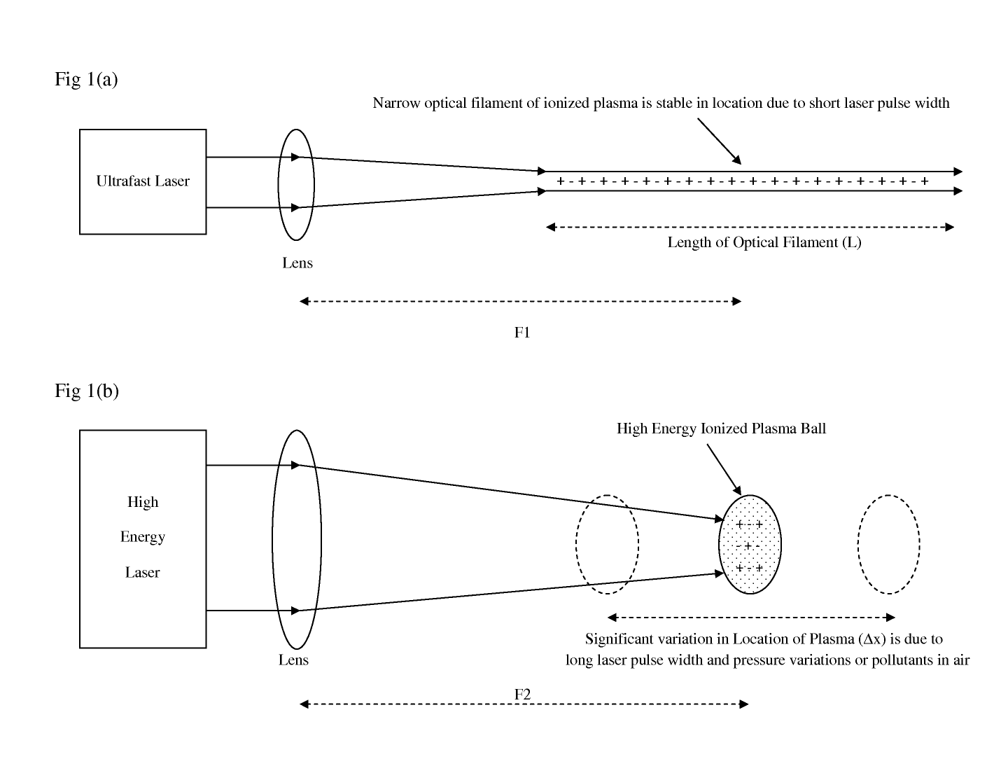

FIG. 1 shows the two key components of the invention separately. In FIG. 1(a) the output from an ultrafast laser is focused by a lens with a focal length F1 to produce an optical filament of length L. In FIG. 1(b) the output from a high pulse energy laser is focused by a lens with a focal length F2 to produce a large volume of highly ionized plasma. Because of the relatively non-deterministic nature of this process there exists a range of random variation in the exact location of the laser-produced plasma Δx. In general, the greater the focal length F2 is the greater the range of variation of the plasma location Δx for each pulse. The magnitude of variation can be as large as several tens of meters if the focal length is of the order of several kilometers or more.

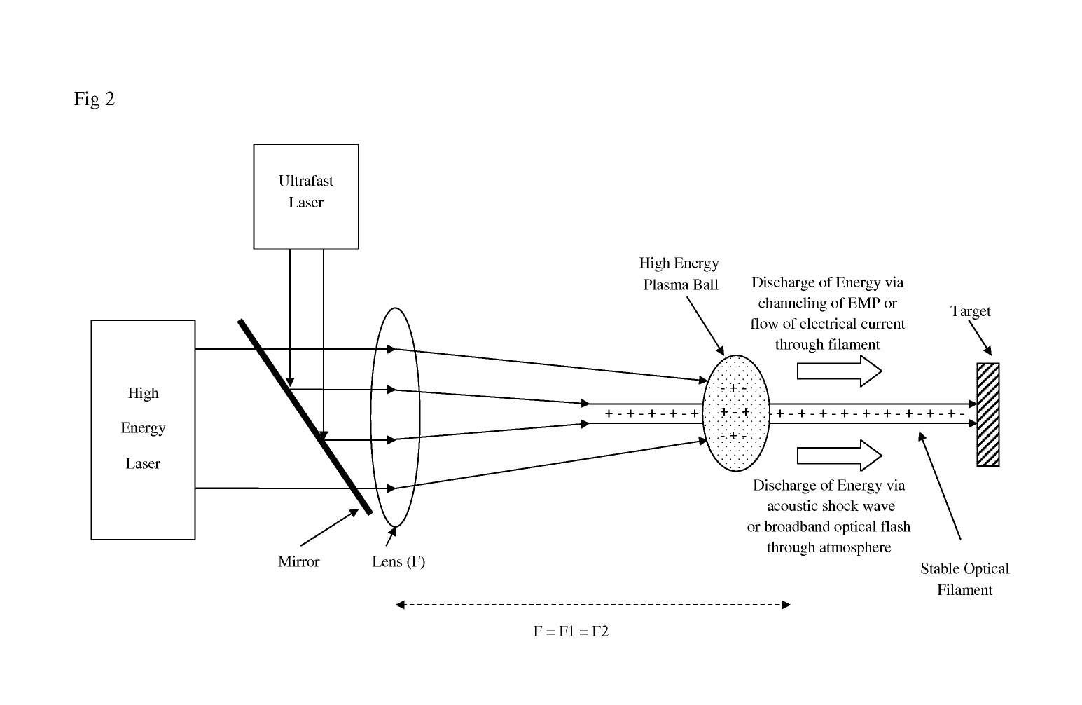

FIG. 2 shows a preferred embodiment of the invention when the two key components are combined. In this embodiment the optical arrangement uses the same focusing lens such that its focal length F=F1=F2. If this optical arrangement results in an optical filament with length L being greater than the range of variation of the location of the high energy plasma Δx then the two plasmas will always combine to form a single plasma volume. If this is the case then electrons from the high energy portion of the plasma pulses will be able to conduct directly to a target if the farthest end of the optical filament is controlled so that it touches the target. This process may cause disorientation or damage to the target, depending on the size of the high pulse energy laser and the nature of the target. In addition to the potential energy discharge via flow of electrons from the highly energized plasma to the target, an acoustic shock wave and a broadband optical pulse may also be created by the high energy laser pulse which may propagate towards the target. The acoustic shock wave and/or the optical pulse may also provide some degree of disorientation or damage to the target.

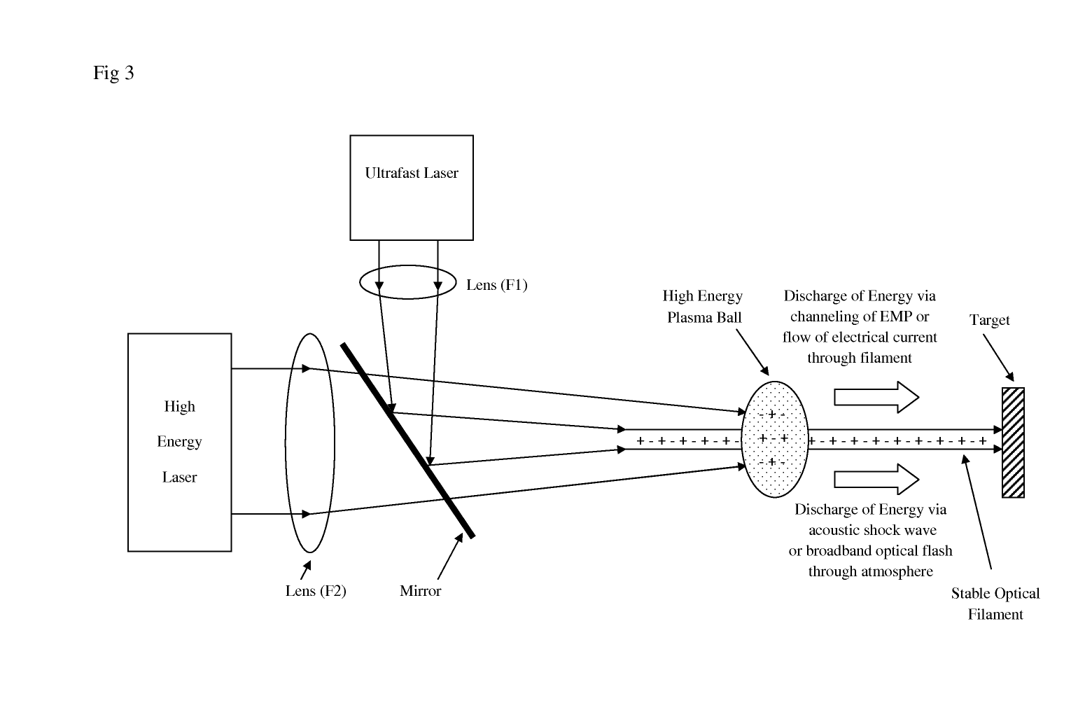

It may be the case that the use of a single focusing lens for both laser beams may not result in the variation in high energy plasma location Δx being less than the length of the optical filament L. Furthermore it may be the case that there is no overlap between the variation in plasma location Δx with the length of the optical filament L using a single optical focusing lens. Consequently other embodiments that offer a greater degree of flexibility or control in focusing arrangements may be preferable. FIG. 3 shows another preferred embodiment of the invention when the two key components are combined. In this embodiment the optical arrangement uses separate lenses for each laser with separate focal lengths F1 and F2. This arrangement allows for optimization of the position of the optical filament with respect to the position of the high energy plasma. As in the previous embodiment, if the length of the optical filament L is greater than the range of variation of the location of the high energy plasma Δx then the two plasmas will always combine to form a single plasma volume and energy from the high energy plasma will be discharged into a target that is in contact with the optical filament.

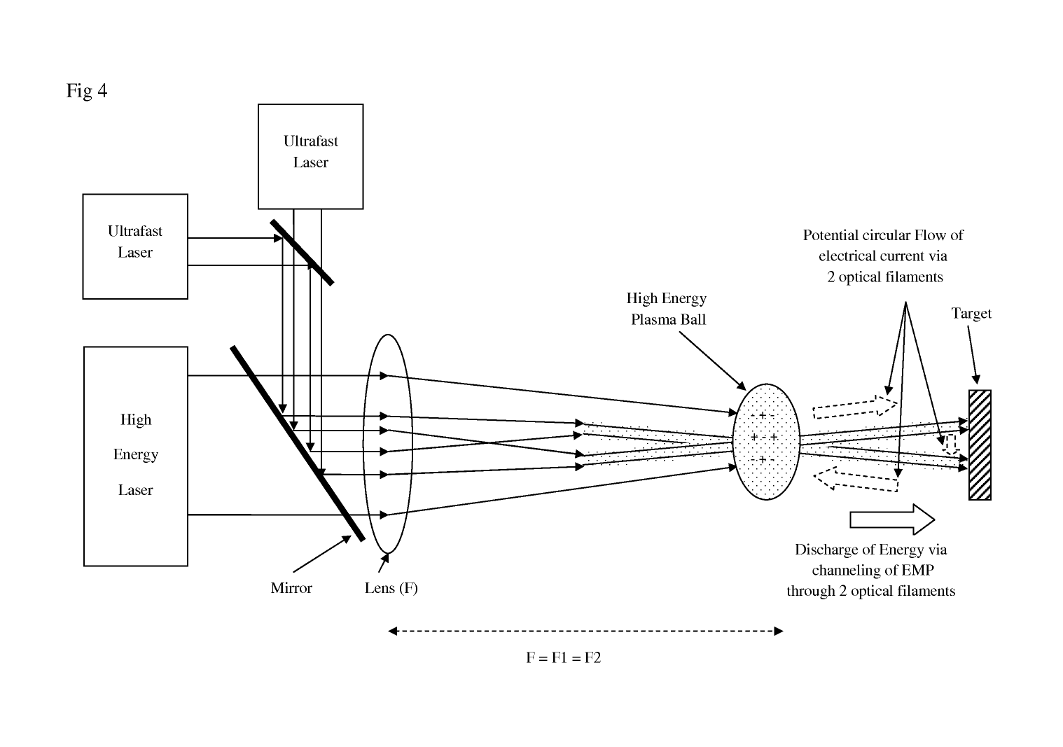

FIG. 4 shows another preferred embodiment of the invention where two separate optical filaments are used instead of one. In this embodiment both optical filaments overlap at or nearby where the high energy plasma is formed but make contact with the target at two separate and distinct locations. Alternatively the two optical filaments may not spatially overlap at all but they both have a spatial and temporal overlap with the high energy plasma. The purpose of embodiments of the invention with two separate optical filaments making contact with the target is to provide two separate optical paths between the high energy plasma and the target. This may allow for a closed electrical circuit for the conduction of current from the energized plasma via one filament, through the target and back to the plasma via the other filament. Allowing such a unidirectional or closed circuit current to flow between the high energy plasma and the target may lead to increased current flow and increased discharge of energy through the target.

Various modifications may be made in details of design and construction and process steps, parameters of operation etc without departing from the scope and ambit of the invention.

1. A dual-laser based method of accurately and efficiently directing energy through the atmosphere over a significant range towards an intended target, said method comprising the steps of;
using an ultrafast laser source, capable of producing a laser pulse with sub-nanosecond pulse duration, combined with focusing optics to create a stable long thin optical plasma filament in the atmosphere with its farthest end physically connected or very close to the target;
using a second different high energy laser source, capable of producing a laser pulse with much higher pulse energy than the ultrafast laser source but with significantly longer pulse duration, combined with focusing optics to create a high energy plasma ball in the atmosphere that is positioned at some physical point along the long optical plasma filament, so that the two plasmas spatially and temporally overlap;
using the stable optical plasma filament to direct, guide or channel energy from the high energy plasma ball to the target, including but not limited to energy emitted from the plasma ball in the form of an electromagnetic pulse (EMP);
and using the directed energy to cause damage to the intended target or any of its components, such that the target is either destroyed, damaged, disabled or disorientated in some manner.

2. A method as in claim 1, where the shorter duration ultrafast laser pulse is initiated either during or shortly after the longer duration high energy laser pulse, so that the optical plasma filament is created through the pre-existing or forming high energy plasma ball.

3. A method as in claim 1, where the ultrafast laser pulse is initiated before the high energy laser pulse, so that the high energy plasma ball is created along the length of the pre-existing optical plasma filament.

4. A method as in claim 1, where the timing of the shorter duration ultrafast laser pulse relative to the longer duration high energy laser pulse, is manipulated so that the degree of spatial and temporal overlap between the two plasmas is optimized for the delivery of maximum directed energy to the target, such optimization being specific to the type of energy being directed.

5. A method as in claim 1, where the creation of an initial stable optical plasma filament is used as a plasma seeding mechanism to improve the focal stability and accuracy of the subsequent creation of the high energy plasma ball along the optical filament length, thereby increasing the focal accuracy and effective range with which the high energy plasma ball can be accurately positioned.

6. A method as in claim 1, where the optical plasma filament is created via a burst or continuous train of ultrafast laser pulses, such that the optical plasma filament effectively exists in a continuous or steady state regime for a significant period of time, instead of using a single ultrafast pulse.

7. A method as in claim 1, where the directed energy is in the form of an electrical discharge of stored energy in the high energy plasma ball, such discharge being electrically conducted via the optical plasma filament to the target, with the resultant electrical current flowing between the plasma ball and target created from an induced difference in electrical potential.

8. A method in claim 1, where the high energy plasma ball emits a broadband optical pulse towards the target, with the plasma ball being positioned sufficiently close to the target so that the optical pulse can cause damage, blinding or disorientation to optical sensors or components in the target, including but not limited to visible and infrared optical sensors.

9. A method as in claim 1, where the high energy plasma ball produces an acoustic shock wave that travels through the atmosphere to the target, with the plasma ball being positioned sufficiently close to the target so that the acoustic shock wave causes damage, disorientation or distraction to the target or any of its components, including but not limited to electronic sensors and radio-frequency sensors.

10. A method as in claim 1, where a single laser source is designed to produce two separate laser pulses with significantly different energy and temporal characteristics, so that it effectively produces the same physical effect as a method using two separate laser sources, specifically producing the temporal and spatial overlap of two distinct and different types of plasmas in the atmosphere.

11. A method as in claim 1, where the focal stability, accuracy or range of the method is improved via the addition of additional optical components, including but not limited to adaptive optics and wide aperture optics.

12. A method as in claim 1, where the focusing optics used for the ultrafast laser and the high energy laser are the same and identical.

13. A method as in claim 1, where the focusing optics used for the ultrafast laser and the high energy laser are separate and distinct.

14. A method as in claim 1, where the ultrafast laser source and/or the high energy laser source produce laser pulses with an optical wavelength in the ultraviolet, visible or infrared portions of the electromagnetic spectrum, including but not limited to optical wavelengths ranging from 200 nanometers to 10,000 nanometers.

15. A method as in claim 1, where multiple optical plasma filaments are created by one or more ultrafast laser sources to improve the accuracy, energy delivery efficiency or potential range of the method.

16. A method as in claim 1, where the target is comprised of non-biological materials or components, including but not limited to optical, mechanical, electrical and electronic components, that may be susceptible to damage or destruction caused by EMP, electrical energy, broadband optical energy or acoustic shock waves.

17. A method as in claim 1, where the target is comprised of living biological matter, including but not limited to humans, that are susceptible to damage, discomfort or blinding caused by EMP, electrical energy, broadband optical energy or acoustic waves.

18. A method as in claim 1, where the target is an airborne device or vehicle, such as a guided missile, rocket, unmanned aerial vehicle or manned aircraft, and the directed energy is intended to destroy, damage, disable or disorientate the target or any of its components.

19. A method as in claim 1, where the purpose of the method is military in nature, including but not limited to use as a non-lethal directed energy weapon that delivers electromagnetic, electrical, optical or acoustic energy to a target, in such a way that the target or any of its components are neutralized, damaged, disabled, disorientated or repelled.

20. A method as in claim 1, where the purpose of the method is scientific, industrial or non-military in nature, including but not limited to use for particle beam acceleration via laser wake-field processes, use as an intense spectral source for remote spectroscopic sensing, or use as a remote ground penetrating radar device.
